(19) United States
(12) Patent Application Publication
(10) Pub. No.: US 2008/0152778 A1
(43) Pub. Date: Jun. 26, 2008

(54) METHOD OF PRODUCING A BEVERAGE, A BEVERAGE, AND A DEVICE FOR PRODUCING A BEVERAGE

(76) Inventors: Hiroaki Kosugi, Kawasaki (JP); Masahiro Hirano, Tokyo (JP); Hiroshi Hiramatsu, Machida-City (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/616,128

(22) Filed: Dec. 26, 2006

(51) Int. Cl. A23L 2/00; A23L 2/72

(52) U.S. Cl. 426/590; 202/84; 426/422

(57) ABSTRACT

Disclosed herein is a method of producing a beverage comprising filtration sterilizing an untreated liquid to yield a filtration sterilized permeable constituent and an impermeable constituent, heating and disinfecting the impermeable constituent, and mixing the heat disinfected impermeable constituent with the filtration sterilized permeable constituent. Also disclosed herein is a beverage produced by such a method and a device for carrying out this method.

### TECHNICAL FIELD OF THE INVENTION

Disclosed herein is a method of producing a beverage, a beverage, and a device for producing a beverage, wherein deterioration of the flavor due to heating is reduced or inhibited without removing constituents in the beverage solution.

In general, beverages are produced by mixing all of the starting materials followed by disinfection treatment and/or sterilization treatment from the perspective of food hygiene.

Heat disinfection is commonly used, including retort disinfection, UHT disinfection (short-term disinfection at ultra-high temperatures), and the like. There are also cases in which the so-called non-heating packing method is used in which sterilization treatment using a filtration filter is followed by sterile packing, for instance, in the case of mineral water.

However, beverages such as coffee, tea, and fruit juices have constituents that impart their unique flavors and those constituents may be subject to deterioration and/or degeneration due to heat disinfection.

Furthermore, while the aromatic/flavor constituents do not suffer degeneration when sterilization treatment using a filtration filter is carried out, the molecules found in the solution that are larger than the pore diameter of the filter may be removed, possibly resulting in a loss of body and/or blandness of flavor.

The prior art, for instance, the Gazette of Japanese Kokai Publication Hei-10-304823, proposes a method of producing coffee beverages containing milk in which milk constituents that have been heat disinfected separately are admixed with the coffee constituents that have been filtration sterilized without heat through the use of a filter. However, in this method, the constituents of coffee that are larger than the pore diameter of the filter, for instance, the important constituents that contribute to coffee flavor, are removed through the step of filter sterilization, resulting in a loss of the inherent coffee taste.

### BRIEF DESCRIPTION OF THE DRAWINGS

FIG. 1 is a diagram illustrating a first embodiment of the beverage production device of the present disclosure.

FIG. 2 is a diagram illustrating a second embodiment of the beverage production device of the present disclosure.

FIG. 3 is a diagram illustrating a third embodiment of the beverage production device of the present disclosure.

FIG. 4 is a diagram illustrating a fourth embodiment of the beverage production device of the present disclosure.

### DISCLOSURE OF THE INVENTION

It is desirable to provide a beverage from which constituents in the beverage solution are not substantially removed and in which flavor deterioration due to heating is reduced or inhibited.

The present inventors have conducted research focusing on the difficulty of preventing degeneration or deterioration of flavor constituents during disinfection when employing heating disinfection, and also focusing on the fact that the non-heating sterilization method that employs filtration removes important constituents that contribute to the beverage flavor while preventing deterioration of the constituents caused by heating.

Analysis by laser diffraction particle size distribution equipment of the size of particles contained in coffee extract reveals a distribution with a peak ranging from 1 to 10 μm, and microscopic observation reveals comparatively large particles having particle sizes ranging from 20 to 50 μm.

Furthermore, filtration of coffee extract using a filtration filter followed by measurement of the changes in the soluble solid fraction of the permeable solution revealed a decrease of more than 2 wt % in the solid fraction using a filter with pore diameter of 0.5 μm and a decrease of more than 10 wt % using a filter with pore diameter of 0.2 μm. These results indicate a significant decrease in the soluble solid fraction as a result of the filtration.

The comparatively large particles that are removed by such filtration treatment may include, for example, polysaccharides, proteins, fats, and complexes thereof, all of which are important constituents that contribute to the body and aftertaste of beverages.

In light of the aforementioned results and in consideration thereof, the present inventors found that a beverage with improved flavor and body that suffers little or no loss of its inherent taste may be produced by a production method comprising:

(1) filtration sterilizing an untreated liquid to yield a filtration sterilized permeable constituent and an impermeable constituent,

(2) heat disinfecting the impermeable constituent, and

(3) mixing the heat disinfected impermeable constituent and the filtration sterilized permeable constituent.

Thus, disclosed herein is a method of producing a beverage, comprising:

(1) sterilizing an untreated liquid by filtration to yield a filtration sterilized permeable constituent and an impermeable constituent,

(2) heating and disinfecting the impermeable constituent, and

(3) mixing the heat disinfected impermeable constituent and the filtration sterilized permeable constituent.

In one embodiment, the amount of filtration sterilized permeable constituent obtained in step 1 ranges from 10 wt % to 90 wt % relative to the total weight of the untreated liquid.

According to another embodiment, the filtration sterilization may be carried out at a temperature ranging from 5° C. to 55° C.

As used herein, the term “heat disinfected” refers to any liquid which has undergone at least one of various types of heat treatments described herein. Such a heat disinfected liquid may be a heated liquid, or optionally, may be cooled according to conventional methods known in the art to bring the heat disinfected liquid to a lower temperature, for instance, room temperature or below. In the case of the production methods described herein, in step (c), the heat disinfected impermeable constituent may be mixed with the permeable constituent while in a heated state, or optionally, it may be cooled to a lower temperature prior to mixing with the permeable constituent.

In yet another embodiment, the mixed liquid from step 3 may be refluxed and mixed together with the impermeable constituent in step 2 and the resulting mixture may then be heated and disinfected.

According to a further embodiment, in step 3, the heat disinfected impermeable constituent and filtration sterilized permeable constituent may further be mixed with at least one additional constituent that has been separately heated and disinfected.

In still a further embodiment, the method of the present disclosure may include a further step wherein the impermeable constituent from step 1 is refluxed and mixed with untreated liquid to yield a filtration sterilized permeable constituent and an impermeable constituent that has been circulated in a tank of untreated liquid and recovered.

The untreated liquid may be chosen, for example, from coffee, green tea, barley tea, black tea, oolong tea, herb extract, fruit juice, vegetable juice, and cocoa.

According to another embodiment, the filtration sterilization may be carried out using a filter with pore diameter of less than or equal to 0.2 μm.

Also disclosed herein is a beverage produced by the methods of the present disclosure, which suffers little or no removal of constituents in the beverage solution and in which deterioration of flavor due to heating is reduced or inhibited. This beverage may be characterized by improved flavor and body.

In at least one embodiment, the beverage may further comprise at least one anti-oxidizing agent. Suitable anti-oxidizing agents may include, but are not limited to, ascorbic acid, erythorbic acid, and water-soluble salts and esters thereof; tocopherol; rutin; Myrica rubra extract; raw coffee bean extract; grape seed extract; catechin; and tea extract.

Further disclosed herein is a device for producing a beverage in accordance with the methods of the present disclosure.

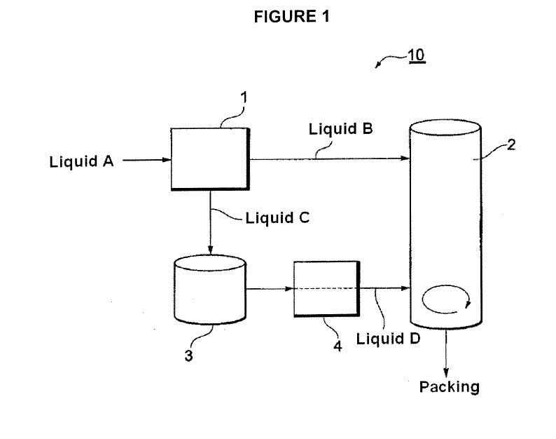

One embodiment of the beverage production method and device of the present disclosure is illustrated in FIG. 1 and explained in more detail below.

As shown in FIG. 1, production device 10 comprises a filtration sterilization device 1 that separates the permeable constituent (liquid B) and the impermeable constituent (liquid C) after the influx of untreated liquid (liquid A). After filtration, the impermeable constituent (liquid C) is recovered in tank 3 and subsequently transferred to heating disinfection device 4, to produce disinfected liquid D. The permeable constituent (liquid B) is transferred to aseptic tank 2.

Filtration sterilization device 1 may be chosen from dead-end filtration devices, in which the untreated liquid is circulated at right angles to the membrane surface for filtration of the entire amount, and crossflow filtration devices, in which the untreated liquid is circulated while flowing parallel to the membrane surface to reduce adhesion of impurities to the membrane surface.

In at least one embodiment, filtration sterilization device 1 is a crossflow filtration device, since comparatively large particles contained in a beverage solution may not readily adhere to a membrane.

The untreated liquid (liquid A) may be filtered by means of a filter that is fitted to filtration sterilization device 1 so that the filtration sterilized permeable constituent that passes through the filter is collected in aseptic tank 2 as liquid B while the impermeable constituent that does not pass through the filter is collected in tank 3 as liquid C.

Next, liquid C may be disinfected by UHT disinfection, for example, in heating disinfection device 4, to form liquid D that is collected in aseptic tank 2 where it is mixed with liquid B under sterile conditions, optionally followed by packing in containers.

The UHT disinfection treatment may be carried out at a temperature ranging, for example, from 100 to 140⁰ C.

According to one aspect of the present disclosure, the amount of liquid exposed to heat is reduced in the production method while removing the initial constituents of the solution, and a beverage may be obtained in which deterioration due to heat is reduced or inhibited overall.

The embodiment depicted in FIG. 1 may be suitable for carrying out a method of producing beverages such as black coffee, tea-based beverages, fruit juices, vegetable juices, and other beverages containing ingredients that are susceptible to heat.

In at least one embodiment, the amount of permeable constituent obtained in the first step of the production method may range, for example, from 10 wt % to 90 wt % relative to the total weight of the untreated liquid.

According to another embodiment, the filtration sterilization may be carried out at a temperature ranging from 5° C. to 55° C., for example, the filtration sterilization may be carried out in an unheated state.

Various constituents in the untreated liquid, such as tea-based extracts, anti-oxidizing agents, flavors, colorant, oligosaccharides, and other functional constituents, may be susceptible to heat damage. Thus, the damage caused by heat disinfection can be greatly reduced by employing filtration sterilization in an unheated state.

In a further embodiment, the filtration sterilization may be carried out in a heated state, in which case the temperature may range, for instance, from 40° C. to 55° C.

The damage from heating disinfection may be greatly reduced through filtration sterilization at a fixed heated state, for example, in the case of oils and fats found in coffee extracts, among various other constituents which may be present in the untreated liquid.

According to yet another embodiment, in the second step of the production method, at least one mixed liquid of additional constituents may be added to the impermeable constituent, followed by heating and disinfecting of the resulting mixture.

In this embodiment, heat disinfection subsequent to the mixture of additional constituents such as milk constituents and emulsifiers with the impermeable constituents may be suitable because additional constituents may markedly lower the efficiency of filtration sterilization. The effects of filtration sterilization may be more efficiently attained by employing this embodiment of the production method.

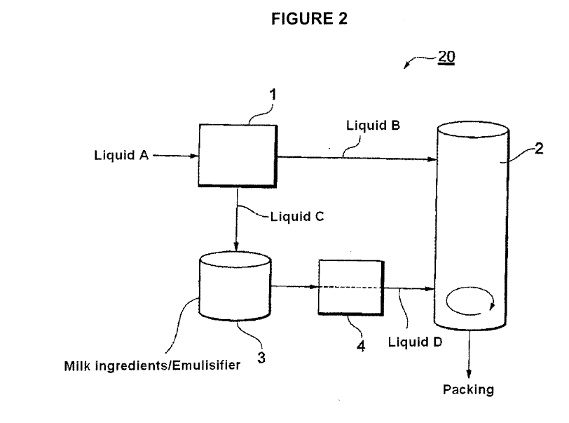

FIG. 2 illustrates another embodiment of a method of producing beverages pursuant to the present disclosure. Referring now to FIG. 2, the beverage production device 20 differs from that shown in FIG. 1 in that it has a means of adding additional constituents to tank 3. In this figure, the mixed liquid comprising impermeable constituent (liquid C) and the additional constituents that are mixed in tank 3 is subjected to heat disinfection by heating disinfection device 4 to form liquid D which may then be collected in tank 2, mixed with liquid B and packed in a container.

The embodiment depicted in FIG. 2 may be suitable for producing milk coffee and milk tea, which may contain milk constituents and/or emulsifiers as additional constituents.

This embodiment may also be suitable for producing beverages in which constituents such as fruit juice, vegetable juice, green powdered tea, coca powder, fine coffee-bean powder, and the like, which may contain pulp as the additional constituent, are blended.

In another embodiment, additional constituents that have been heat disinfected separately may also be blended when mixing the heat disinfected impermeable constituents and the filtration sterilized permeable constituents in the third step of the production method.

Blending subsequent to separate heat disinfections under different conditions may be suitable when additional constituents such as milk constituents and emulsifiers may markedly lower the efficiency of filtration sterilization. The effects of filtration sterilization may be more efficiently attained by employing this embodiment of the production method.

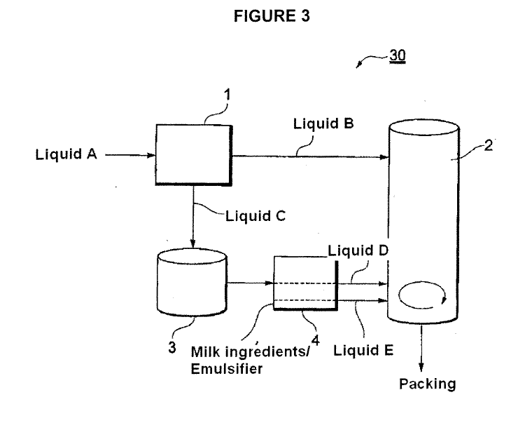

FIG. 3 depicts yet another embodiment of the method of producing beverages pursuant to the present disclosure.

Referring now to FIG. 3, the beverage production device 30 differs from that shown in FIG. 2 in that additional constituents are subjected to heat disinfection separately from the impermeable constituent (liquid C). In this embodiment, impermeable constituent (liquid C) is collected in tank 3 and then subjected to heat disinfection via heating disinfection device 4 to form liquid D while the additional constituents are separately subjected to heat disinfection via heating disinfection device 4 to form liquid E, both of which are collected in aseptic tank 2 with permeable constituent (liquid B) where they are mixed under sterile conditions and may be packed in containers.

The embodiment shown in FIG. 3 may be suitable for producing milk coffee and milk tea, which may contain milk constituents and/or emulsifiers as the additional constituents.

This embodiment may also be suitable for producing beverages in which constituents such as fruit juice, vegetable juice, green powdered tea, coca powder, fine coffee-bean powder, and the like, which may contain pulp as the additional constituent, are blended.

According to another embodiment of the production method, the impermeable constituent may be subjected to reflux and mixture with the untreated liquid before the first step. In this case, the first step would yield a filtration sterilized permeable constituent and an impermeable constituent that has been circulated in a tank of untreated liquid and recovered.

A desired amount of soluble solid fraction in the untreated liquid may be collected as the permeable constituent by circulating and collecting the impermeable constituent according to this embodiment.

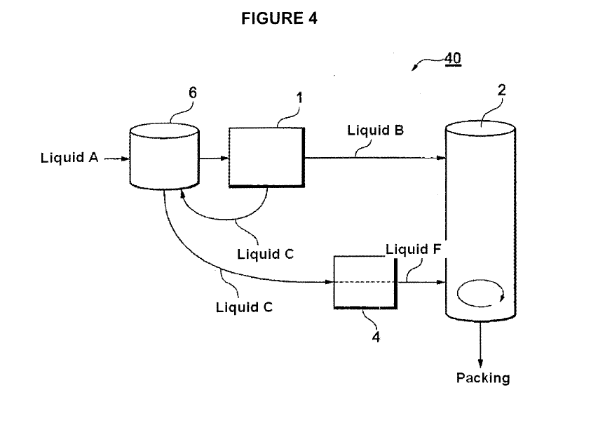

FIG. 4 illustrates a further embodiment of the method of producing beverages pursuant to the present disclosure.

Referring now to FIG. 4, the beverage production device 40 differs from that shown in FIG. 1 in that temporary holding tank 6 for untreated liquid (liquid A) is provided, tank 3 is not provided, and a means of circulating impermeable constituent (liquid C) from filtration sterilization device 1 to tank 6 is provided. In this embodiment, impermeable constituent (liquid C) is subjected to reflux and mixed with liquid A, followed by circulation of impermeable constituent C in tank 6 and heat disinfection by heating disinfection device 4 to form liquid F which is then collected in aseptic tank 2 where liquid B and liquid F are mixed under sterile conditions and then may be packed in containers.

By circulating the impermeable constituent between tank 6 and filtration sterilization device 1 according to this embodiment, it may be possible to collect from 10 to 90 wt % of soluble solid fraction in liquid A, for instance, from 50 to 80 wt % soluble solid fraction.

In at least one embodiment, the untreated liquid may comprise at least one ingredient chosen from coffee, green tea, barley tea, black tea, oolong tea, herb extract, fruit juice, vegetable juice, and cocoa.

According to another embodiment, the untreated liquid may further comprise at least one additional ingredient chosen from milk constituents, emulsifiers, and flavors.

The filtration sterilization of step 1 may be carried out using a filter having pore diameter of less than 0.5 μm, and in at least one embodiment, the filter may have a pore diameter of less than or equal to 0.2 μm, when circulating the final beverage product at ambient temperature.

In a further embodiment, the filter may have a pore diameter of 0.2 μm, since the use of a filter having an excessively small pore diameter may have adverse effects on the operational efficiency and processing duration during production.

According to yet another embodiment, all or part of the steps in the production method may be performed under oxygen-free conditions.

For example, a coffee extractor or various types of tanks may be filled with deionized water, followed by discharge of said deionized water from the interior while pumping in nitrogen, an inert gas, to thereby displace oxygen with nitrogen in the coffee extractor or tank.

This embodiment may yield a beverage having improved flavor and aroma since deterioration of the flavor can be further reduced or inhibited due to the lack of oxygen in these steps.

A beverage pursuant to the present disclosure may be produced by any of the production methods described herein.

Examples of beverages which may be produced according to the methods disclosed herein include coffee beverages, teas, fruit juice beverages, herb beverages, vegetable beverages, and cocoa beverages.

The beverage pursuant to the present disclosure may be produced by any of the production methods described herein and may further comprise at least one anti-oxidizing agent.

Non-limiting examples of suitable anti-oxidizing agents include ascorbic acid, erythorbic acid, and water-soluble salts and esters thereof; tocopherol; rutin; Myrica rubra extract; raw coffee bean extract; grape seed extract; catechin; and tea extract.

The at least one anti-oxidant may serve to maintain the flavor attained through the production methods described herein, and by adding at least one anti-oxidizing agent, the rich flavor inherent in the beverage may be enjoyed over a longer period of time.

Further disclosed herein are production devices for producing beverages pursuant to the present disclosure and which may be used in the production methods of the present disclosure.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the disclosure are approximations, unless otherwise indicated the numerical values set forth in the specific examples are reported as precisely as possible. Any numerical value, however, inherently contains certain errors necessarily resulting from the standard deviation found in their respective testing measurements.

By way of non-limiting illustration, concrete examples of certain embodiments of the present disclosure are given below.

### EXAMPLES

### Example 1a

### Black Coffee (Filtration Sterilization) [Inventive]

Coffee beans were roasted, ground, and treated by conventional means to yield 300 kg of coffee extract (15 kg total coffee solids) that was mixed with a suitable amount of sodium bicarbonate solution to adjust the pH.

Next, this mixture was circulated by a pump in the crossflow method using a filter having a 0.2 μm pore diameter between the filtration device and the storage tank to complete filtration sterilization, thereby yielding 240 kg of permeable constituent and 60 kg of impermeable constituent. The permeable constituent was collected in a sterile tank while the impermeable constituent was subjected to UHT disinfection (131° C., 30 seconds), followed by collection in a sterile tank. It was then mixed with the permeable constituent.

Next, a fixed amount of the mixed liquid was set (1000 kg) with deionized water that had been subjected to disinfection treatment so as to reach an appropriate concentration, followed by sterile packing in sealed containers.

### Example 1b

### Black Coffee (Retort Disinfection) [Comparative]

Coffee beans were roasted, ground, and treated by conventional means to yield 300 kg of coffee extract (15 kg total coffee solids) that was mixed with a suitable amount of sodium bicarbonate solution to adjust the pH.

Next, a fixed amount of the mixture was set (1000 kg) with deionized water so as to reach an appropriate concentration, followed by packing in sealed containers, and retort disinfection (115° C., 20 minutes).

### Example 2a

### Coffee Containing Sugar/Milk (Filtration Sterilization) [Inventive]

A solution of 35 kg of sugar, 100 kg of milk, and 1.5 kg of emulsifier dissolved in deionized water was emulsified using a homogenizer, and the resulting mixture of sugar and milk was subjected to UHT disinfection (139° C., 30 seconds) and collected in a sterile tank.

In addition, coffee beans were roasted, ground, and treated by conventional means to yield 270 kg of coffee extract (13.5 kg total coffee solids) that was mixed with a suitable amount of sodium bicarbonate solution to adjust the pH.

Next, this mixture was subjected to filtration sterilization by the crossflow method using a filter having a 0.2 μm pore diameter, thereby yielding 216 kg of permeable constituent and 54 kg of impermeable constituent. The permeable constituent was collected in a sterile tank and the impermeable constituent was subjected to UHT disinfection (131° C., 30 seconds), followed by collection in a sterile tank and mixture with the permeable constituent.

Next, a fixed amount of the mixed liquid was set (1000 kg) with deionized water subjected to disinfection so as to reach an appropriate concentration, followed by sterile packing in sealed containers.

### Example 2b

### Coffee Containing Sugar/Milk (Retort Disinfection) [Comparative]

Coffee beans were roasted, ground, and treated by conventional means to yield 270 kg of coffee extract (13.5 kg total coffee solids) that was mixed with a suitable amount of sodium bicarbonate solution to adjust the pH.

A solution of 35 kg of sugar, 100 kg of milk, and 1.5 kg of emulsifier dissolved in deionized water was mixed to form a milk/sugar mixture, a fixed amount of which was set (1000 kg) with deionized water so as to reach an appropriate concentration, followed by emulsification using a homogenizer, packing in sealed containers, and retort disinfection (123° C., 20 minutes).

### Evaluation Method

The individual samples of black coffee and milk/sugar coffee prepared in Inventive Examples 1a and 2a and Comparative Examples 1b and 2b were packed in 190 g cans that were directly evaluated by a 12-member in-house panel.

The eight evaluation factors included the intensity and desirability of the coffee aroma, the intensity and desirability of the coffee flavor, the intensity and desirability of acidity, the desirability of coffee aftertaste, and the overall evaluation of flavor. The evaluation was scored on a scale of 1 to 9 (desirability: worst 1 to best 9, intensity: mild 1 to strong 9). The mean of the individual scores of the 12-member panelists was determined.

Table 1 presents the evaluation results of black coffee, and Table 2 presents the evaluation results of a milk/sugar coffee beverage.

TABLE 1
Evaluation results of black coffee

| | Score (Nine-stage evaluation, | | |
|---|---|---|---|
| | mean score) | | Significant |
| | Inventive | Comparative | difference |
| | Example 1a | Example 1b | standard |
| Intensity of coffee aroma | 5.8 | 4.2 | |
| Desirability of coffee | 5.9 | 4.0 | *5% |
| aroma | | | |
| Intensity of coffee flavor | 5.1 | 4.7 | |
| Desirability of coffee | 5.8 | 4.1 | *5% |
| flavor | | | |
| Desirability of aftertaste | 5.7 | 4.1 | **1% |
| Intensity of acidity | 4.3 | 7.2 | **1% |
| Desirability of acidity | 5.3 | 3.0 | *5% |
| Overall evaluation of | 5.6 | 3.6 | **1% |
| flavor | | | |

TABLE 2
Evaluation results of milk/sugar coffee beverage

| | Score (Nine-stage evaluation, | | |
|---|---|---|---|
| | mean score) | | Significant |
| | Inventive | Comparative | difference |
| | Example 2a | Example 2b | standard |
| Intensity of coffee aroma | 4.2 | 3.9 | |
| Desirability of coffee | 5.1 | 4.1 | |
| aroma | | | |
| Intensity of coffee flavor | 3.4 | 4.3 | *5% |
| Desirability of coffee | 5.0 | 4.3 | |
| flavor | | | |
| Desirability of aftertaste | 5.3 | 4.6 | |
| Intensity of acidity | 4.3 | 5.4 | **1% |
| Desirability of acidity | 6.2 | 4.3 | *5% |
| Overall evaluation of | 5.7 | 4.3 | *5% |
| flavor | | | |

### Evaluation Results

Tables 1 and 2 indicate that Inventive Examples 1a and 2a were superior to Comparative Examples 1 b and 2b in terms of many of the evaluation items, including the intensity and desirability of the coffee aroma, the desirability of coffee aftertaste, the desirability of the coffee flavor, the desirability of acidity, and the overall evaluation. These results indicate a desirable product.

Further, the inherent features of coffee aroma were inferior in Comparative Examples 1 b and 2b, the acidity was greater, and an aftertaste lingered. The product was determined to be inferior to that of Inventive Examples 1 a and 2a.

### Example 3

### Black Coffee (Filtration Sterilized, Oxygen-Free Production Method) [Inventive]

The steps of Example 1a were repeated as follows under oxygen-free conditions in Example 3.

A coffee extractor and various types of tanks were filled with deionized water, followed by discharge of the deionized water from the interior while pumping in nitrogen, an inert gas, to thereby displace oxygen with nitrogen in the coffee extractor and tank. In addition, deionized water treated so that the dissolved oxygen concentration would be not more than 50 ppb was used for extraction and coffee preparation.

Even when using a production method in which oxygen was removed to a great extent in the procedures, coffee was produced having outstanding flavor and aroma similarly to the aforementioned results.

The method of production pursuant to the present disclosure permits the production of various beverages in addition to coffee that have improved body and aftertaste in which the flavor changes typified by decrease or deterioration of aroma and increase of acidity due to heat disinfection are reduced or inhibited.

What is claimed is:

1. A method of producing a beverage comprising:
(a) filtration sterilizing an untreated liquid to yield a filtration sterilized permeable constituent and an impermeable constituent,
(b) heating and disinfecting the impermeable constituent, and
(c) mixing the heat disinfected impermeable constituent and the filtration sterilized permeable constituent.

2. The method of claim 1, wherein the amount of filtration sterilized permeable constituent obtained in step (a) ranges from 10 wt % to 90 wt % relative to the total weight of the untreated liquid.

3. The method of claim 1, wherein the filtration sterilization is carried out at a temperature ranging from 5° C. to 55° C.

4. The method of claim 1, wherein a liquid comprising at least one additional constituent is added to the impermeable constituent in step (b) and the resulting mixture is heated and disinfected.

5. The method of claim 1, wherein, in step (c), at least one additional constituent that has been heated and disinfected separately is mixed together with the heat disinfected impermeable constituent and the filtration sterilized permeable constituent.

6. The method of claim 1, wherein at least a portion of the impermeable constituent from step (a) is refluxed and mixed with the untreated liquid to yield a filtration sterilized permeable constituent and an impermeable constituent that has been circulated in a tank of untreated liquid and recovered.

7. The method of claim 1, wherein the untreated liquid is chosen from coffee, green tea, barley tea, black tea, oolong tea, herb extract, fruit juice, vegetable juice, and cocoa.

8. The method of claim 1, wherein the filtration sterilization is carried out using a filter with pore diameter of less than or equal to 0.2 μm.

9. A beverage produced by the method of claim 1, further comprising at least one anti-oxidizing agent.

10. The beverage of claim 9, wherein the at least one anti-oxidizing agent is chosen from ascorbic acid, erythorbic acid, and water-soluble salts and esters thereof; tocopherol; rutin; Myrica rubra extract; raw coffee bean extract; grape seed extract; catechin; and tea extract.

11. A device for carrying out the method of claim 1, comprising:
(a) at least one filtration sterilization device for filtering the untreated liquid to yield a filtration sterilized permeable constituent and an impermeable constituent,
(b) at least one heat disinfection device for heating and disinfecting the impermeable constituent, and
(c) at least one zone for mixing the heat disinfected impermeable constituent and the filtration sterilized permeable constituent.
